(19) United States
(12) Patent Application Publication
(10) Pub. No.: US 2007/0159081 A1
(43) Pub. Date: Jul. 12, 2007

(54) Organic electroluminescent device comprising scan lines having the same resistance

(75) Inventor: Hyo Dae Bae, Dalseo-gu (KR)

Correspondence Address: KED & ASSOCIATES, LLP, P.O. Box 221200, Chantilly, VA, 20153-1200, US

(73) Assignee: LG Electronics Inc.

(21) Appl. No.: 11/515,793

(22) Filed: Sep. 6, 2006

(30) Foreign Application Priority Data
Dec. 22, 2005 (KR) 10-2005-0127955

(51) Int. Cl. H01J 11/00; H01J 19/42; H01J 1/62

(52) U.S. Cl. 313/505; 313/504; 313/512; 313/234; 313/243

(57) ABSTRACT

The present invention discloses the organic electroluminescent device in which a plurality of scan lines can be arranged without the spatial limitation to maintain identically resistances of the scan lines. The organic electroluminescent device according to the present invention comprising a plurality of scan lines connected electrically a plurality of cathode electrodes is characterized in that each scan line has a length which is the same as that (those) of the neighboring scan line(s). The scan line has at least one portion which is bent with a certain angle, and the bending frequency of any one scan line is more than that of the scan line formed at an outer side thereof Also, the bending angle of the bent portion of any one scan line is smaller than that of the scan line formed at an outer side thereof.

### BACKGROUND OF THE INVENTION

1. Field of the Invention

The present invention relates to an organic electroluminescent device, particularly relates to an organic electroluminescent device which can be driven stably by scan lines having the same resistance values.

2. Description of the Related Art

Organic electroluminescence is the phenomenon which excitons are formed in an (low molecular or high molecular) organic material thin film by re-combining holes injected through an anode with electrons injected through a cathode, and light with specific wavelength is generated.

The organic electroluminescent device using the above phenomenon has a basic structure as illustrated in FIG. 1. The basic structure of the organic electroluminescent device includes a glass substrate 200, an indium-tin-oxide layer 102 (hereinafter, referred as “ITO layer”) formed on the upper side of the glass substrate 200 and acting as anode electrode, an insulating layer, an organic material layer, and a metal layer 104 acting as cathode electrode in the order. Walls (not shown) are formed to deposit the metal layers 104 separately on the ITO layer 102.

FIG. 2 is a sectional view of the organic electroluminescent device shown in FIG. 1 and shows that a cap 106 is bonded to the substrate 200 as shown in FIG. 1. As shown in FIG. 2, a plurality of data lines 111 and scan lines 110a and 110b are formed on an outer portion of an active area 100 including a plurality of ITO layers 102 (anode electrodes) and a plurality of metal layers 104 (cathode electrodes). The data lines 111 and the scan lines 110a and 110b are connected electrically to the anode electrodes 102 and the cathode electrodes 104. In FIG. 2, reference numeral “108” which is not described indicates a moisture absorbent sheet (so called as “getter”) attached to an inner surface of the cap 106 through an adhesive 107.

For convenience' sake, on the other hand, only four (4) anode electrodes 102 and four (4) data lines 111, four (4) cathode electrodes 104 and four (4) scan lines 110a and 110b are shown in FIG. 1, however, in actual, much more electrodes and lines are formed on the substrate 200.

FIG. 3 is a plane view of an entire organic electroluminescent device shown in FIG. 1 except the cap 106 and shows a configuration of the actual organic electroluminescent device. As shown in FIG. 3, a plurality of data lines 111 connected to the anode electrodes 102 in the active area 100, respectively, have the same length practically and end portions thereof are arranged on a connecting section P.

However, a plurality of scan lines 110a and 110b connected to ends of the cathode electrodes 104 are extended outsides of the active area 100 and then disposed on the connecting section P formed at a location adjacent to the active area 100 through an end portion thereof.

Due to such configuration, that is, an extension direction of each scan line 110a and 110b and a location of the connecting section P, lengths of the scan lines 110a and 110b differ from each other. That is, in the scan lines 110a and 110b formed in the same area, the outermost scan line has the longest length and the scan line adjacent to the active area 100 has the shortest length.

As described above, the lengths of the scan lines 110a and 110b differ from each other according to the locations thereof, consequently, resistances of the scan lines are different from each other. In general, the data current is flow to a ground through the data line, the pixel and the scan lines, and so the resistance of scan line has influence on the cathode voltage of the corresponding pixel (that is, a brightness of the pixel).

Accordingly, if the resistances of the scan lines 110a and 110b differ from each other, although the same current is applied to the pixels, the pixels emit the lights with the brightness which differ from each other. Consequently, different resistances of the scan lines cause a brightness difference among the pixels when the display device is operated, and due to the above phenomenon, the display failure is generated.

### SUMMARY OF THE INVENTION

The present invention is conceived to solve the above problem caused by a resistance difference among the scan lines constituting the organic electroluminescent device, an object of the present invention is to provide the organic electroluminescent device in which a plurality of scan lines are arranged to maintain identically resistances of the scan lines.

The organic electroluminescent device according to the present invention comprises an active area consisting of anode electrodes, organic material layer and cathode electrodes; data lines connected to the anode electrodes for transmitting electrical signal to the anode electrodes; and scan lines connected to the cathode electrodes for transmitting electrical signal to the cathodes, wherein each scan line has a length which is the same as that (those) of neighboring scan line(s).

In the organic electroluminescent device according to the present invention, the scan line has at least one portion which is bent with a certain angle, and the bending frequency of one scan line is more than that of the scan line formed at an outer side thereof. Also, the bending angle of the bent portion of one scan line is smaller than that of the scan line formed at an outer side thereof

Further, in the organic electroluminescent device according to the present invention, each of the scan lines can have at least one curved portion. At this time, the curved portion of one scan line is smaller than that of the curved portion of the scan line formed at an outer side thereof

### BRIEF DESCRIPTION OF THE DRAWINGS

These and other features, aspects and advantages of the present invention will become better understood with regard to the following description, appended claims, and accompanying drawings where:

FIG. 1 is a plane view illustrating schematically a basic structure of organic electroluminescent device;

FIG. 2 is a sectional view of an organic electroluminescent device, shown in FIG. 1, on which a cap is bonded;

FIG. 3 is a plane view of an entire organic electroluminescent device shown in FIG. 1;

FIG. 4 is a plane view illustrating schematically a basic structure of the organic electroluminescent device according to the present invention;

FIG. 5 is a detail view corresponding to “A” section of FIG. 3 and shows only some of scan lines constituting the organic electroluminescent device shown in FIG. 4; and

FIG. 6 is a view corresponding to FIG. 5 and shows another configuration of the scan lines constituting the organic electroluminescent device according to the present invention.

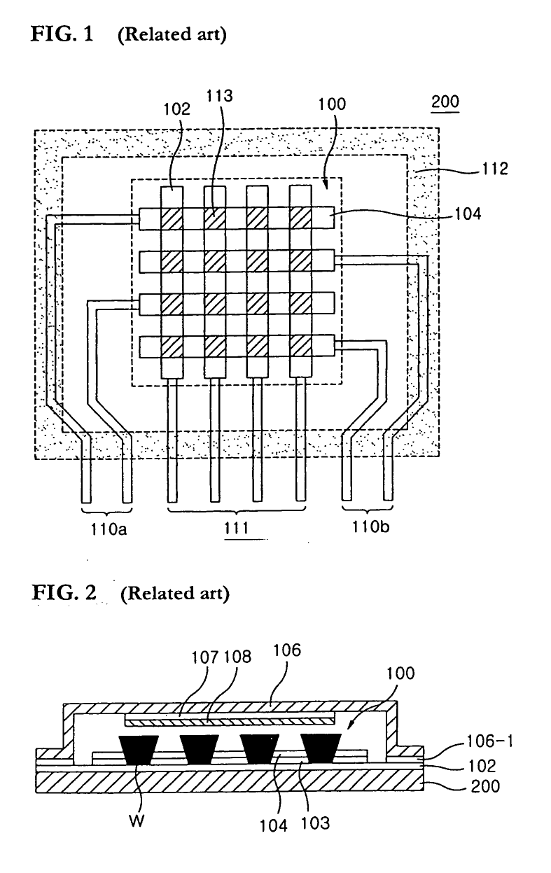

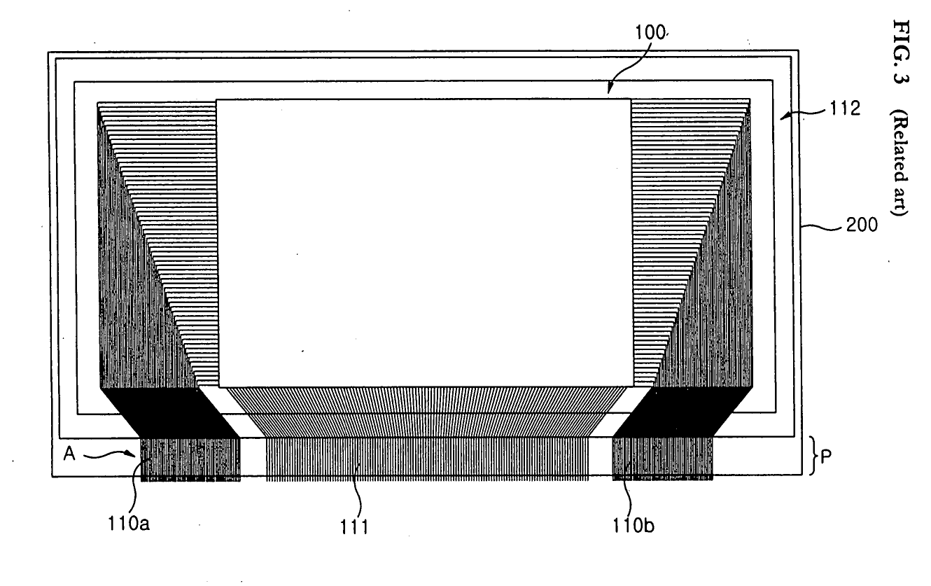

### DETAILED DESCRIPTION OF THE INVENTION

Hereinafter, the preferred embodiments of the present invention will be described in detail with reference to the accompanying drawings. In the following embodiments, the organic electroluminescent device-is provided as an example of the light emitting device. It is, however, obvious that the teaching of the present invention is not limited to the organic electroluminescent device.

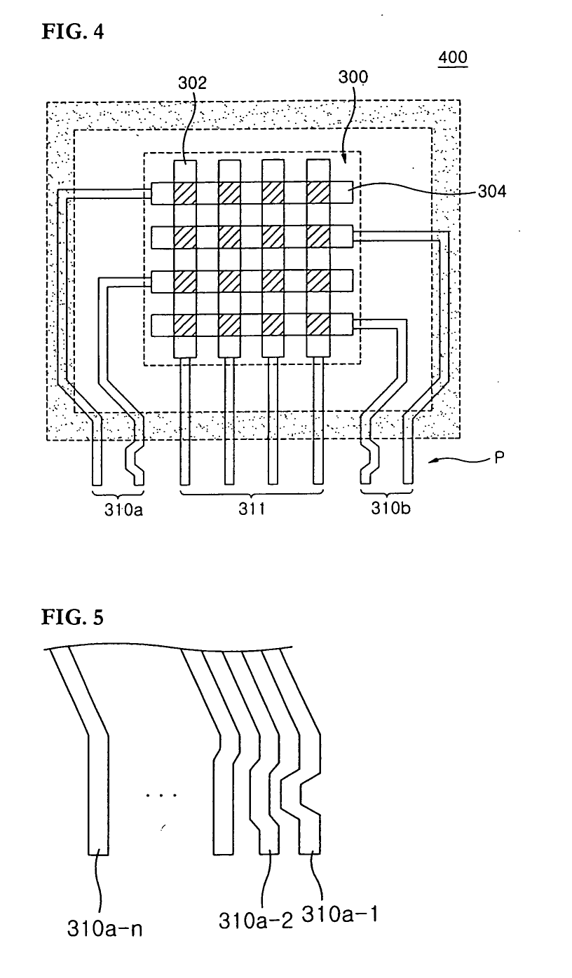

In the organic electroluminescent device according to the present invention as shown in FIG. 4, a plurality of data lines 311 and scan lines 310a and 310b are formed on an outside of an active area 300 on which anode electrodes 302 and cathode electrodes 304 are formed. The data lines 311 and the scan lines 310a and 310b are connected electrically to the anode electrodes 302 and the cathode electrodes 304.

As shown in FIG. 4, a plurality of data lines 311 connected to the anode electrodes 302 in the active area 300, respectively, have the same length practically and end portions thereof are arranged on a connecting section P.

The most import feature of the present invention is that the scan lines 310a and 310b have non-linear sections such that the lengths of the scan lines are the same, and so all the scan lines have the same resistance.

FIG. 5 is a detail view corresponding to “A” section of FIG. 3 and shows only some of the scan lines constituting the organic electroluminescent device according to the present invention. In FIG. 5, on the other hand, reference numerals 310a-1, 310a-2 . . . 310a-n indicate the scan lines.

In the present invention, as shown in FIG. 4 and FIG. 5, the innermost scan line 310a-1 (hereinafter, referred to as “first scan line”) formed on an area which is most adjacent to the active area (300 in FIG. 4) is bent several times, and the scan line 310a-2 (second scan line) formed on an outside of the first scan line 310a-1 is also bent several time. However, a bending angle of each bent portion of the second scan line 310a-2 is larger than that of the first scan line 310a-1, and the bending frequency of the second scan line 310a-2 can be less than that of the first scan line 310a-1. Accordingly, the entire length of the second scan line 310a-2 is the same as that of the first scan line 310a-1.

By applying the configuration described above to all the scan lines, a length of any one scan line becomes identical to that (those) of the neighboring scan line(s), and so all the scan lines 310a-1, 310a-2 . . . 310a-n have the same length and the same resistance.

Here, end portions of the scan lines 310a-1, 310a-2 . . . 310a-n should be disposed on the connecting section (P in FIG. 4).

On the other hand, although FIG. 5 shows that all the scan lines 310a-1, 310a-2 . . . 110a-n have the same length by bending the scan lines at a certain angle, the configuration of the scan lines is not limited to that shown in FIG. 5.

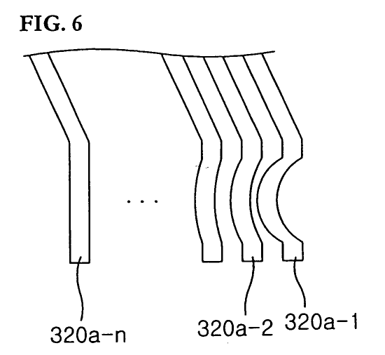

FIG. 6 is a view corresponding to FIG. 5 and shows another configuration of the scan lines constituting the organic electroluminescent device according to the present invention. As shown in FIG. 6, each of the scan lines 320a-1, 320a-2 . . . 320a-n can have at least one curved shaped portion. At this time, and the radius of curvatures of curved portions of the scan lines 320a-1, 320a-2 . . . 320a-n differ from each other.

That is, a radius of curvature of a curved portion of any one scan line, for example, a radius of curvature of the curved portion of the first scan line 320a-1 neighboring the active area (300 in FIG. 4) is less than that of the second scan line 320a-2 formed at an outer side of the first scan line 320a-1.

By applying the configuration described above to all the scan lines, a length of any one scan line becomes identical to that (those) of the neighboring scan line(s), and so all the scan lines 320a-1, 320a-2 . . . 320a-n have the same length and the same resistance.

Here, end portions of the scan lines 320a-1, 320a-2 . . . 320a-n should be disposed on the connecting section (P in FIG. 4).

Further scope of applicability of the present invention will become apparent from the above detailed description. However, it should be understood that the detailed description and specific examples, while indicating preferred embodiments of the invention, are given by way of illustration only, since various changes and modifications within the spirit and scope of the invention will become apparent to those skilled in the art from this detailed description.

For example, although FIG. 4 shows the configuration of the organic electroluminescent device in which the scan lines 310a, 310b connected to the cathode electrodes 304 are extended alternatively from both sides of the active area 300, the present is applicable to the organic electroluminescent device having the configuration in which all the scan lines are extended from only one side of the active area.

Also, the present is applicable to the organic electroluminescent device in which some scan lines connected to the cathode electrodes disposed on a first region of the active area are extended from one side of the active area and remainder of the scan lines connected to the cathode electrodes formed on a second region of the active area are extended from the other side of the active area.

If the present invention is applied to the various kinds of the display devices comprising a plurality of metal lines, all the metal lines have the same length and the same resistance.

In the organic electroluminescent device with the structure as described above, although locations of the scan lines on the outer regions of the active area differ from each other, the scan lines formed such that all of the scan lines have the same length, and so all of the scan lines have the same resistance.

Accordingly, for example, if the current flowed through a first scan line when the first scan line is coupled to a ground is the same in a magnitude as the current flowed through a second scan line when the second scan line is coupled to a ground, since resistance of the first scan line is the same as that of the second scan line, a cathode voltage of the first pixel associated with the first scan line is substantially identical with a cathode voltage of the second pixel associated with the second scan line and corresponding to the second pixel in a magnitude. Consequently, if the data current with the same magnitude are applied to the first and second pixels, the first and second pixels emit the light with the same brightness when the display device is operated.

The preferred embodiments of the present invention have been described for illustrative purposes, and those skilled in the art will appreciate that various modifications, additions, and substitutions are possible, without departing from the scope and spirit of the present invention as disclosed in the accompanying claims.

What is claimed is:

1. An organic electroluminescent device, comprising an active area including anode electrodes, organic material layer and cathode electrodes;
data lines connected to the anode electrodes for transmitting electrical signal to the anode electrodes; and
scan lines connected to the cathode electrodes for transmitting electrical signal to the cathodes, wherein each scan line has a length which is the same as that (those) of neighboring scan line(s).

2. The organic electroluminescent device of claim 1, wherein the scan line has at least one portion which is bent with a certain angle.

3. The organic electroluminescent device of claim 2, wherein the bending frequency of the scan line is more than that of the scan line formed at an outer side thereof.

4. The organic electroluminescent device of claim 3, wherein the bending angle of the bent portion of the scan line is smaller than that of the scan line formed at an outer side thereof.

5. The organic electroluminescent device of claim 1, wherein the scan line has at least one curved portion with a certain radius of curvature.

6. The organic electroluminescent device of claim 5, wherein the curved portion of the scan line has a radius of curvature which is smaller than that of the curved portion of the scan line formed at an outer side thereof.

7. The organic electroluminescent device of claim 1, wherein the scan lines connected to the cathode electrodes are extended alternatively from both sides of the active area.

8. The organic electroluminescent device of claim 1, wherein some of the scan lines connected to the cathode electrodes disposed on one region of the active area are extended from one side of the active area and remainder of the scan lines connected to the cathode electrodes disposed on the other region of the active area are extended from the other side of the active area.

9. The organic electroluminescent device of claim 1, wherein the scan lines connected to the cathode electrodes are extended from only one side of the active area.

10. An organic electroluminescent device, comprising an active area including anode electrodes, organic material layer and cathode electrodes;
data lines connected to the anode electrodes for transmitting electrical signal to the anode electrodes; and
scan lines connected to the cathode electrodes for transmitting electrical signal to the cathodes, wherein the scan has at least one portion which is bent with a certain angle.

11. The organic electroluminescent device of claim 10, wherein the bending frequency of the scan line is more than that of the scan line formed at an outer side

12. The organic electroluminescent device of claim 11, wherein the bending angle of the bent portion of the scan line is smaller than that of the scan line formed at an outer side thereof.

13. An organic electroluminescent device, comprising
an active area including anode electrodes, organic material layer and cathode electrodes;
data lines connected to the anode electrodes for transmitting electrical signal to the anode electrodes; and
scan lines connected to the cathode electrodes for transmitting electrical signal to the cathodes, wherein the scan has at least one curved portion,

14. The organic electroluminescent device of claim 13, wherein the curved portion of the scan line has a radius of curvature which is smaller than that of the curved portion of the scan line formed at an outer side thereof.
